(19) United States
(12) Patent Application Publication
(10) Pub. No.: US 2010/0282693 A1
(43) Pub. Date: Nov. 11, 2010

(54) FILTRATION MEMBRANES

(75) Inventors: Stephen Coulson, Abingdon, Oxfordshire (GB); Richard Wakeman, Exeter, Devon (GB)

Correspondence Address: CONNOLLY BOVE LODGE & HUTZ, LLP, P O BOX 2207, WILMINGTON, DE, 19899, US

(73) Assignee: P2l LTD.

(21) Appl. No.: 12/740,153

(22) PCT Filed: Oct. 28, 2008
(86) PCT No.: PCT/GB08/03644

§ 371 Date: Jul. 28, 2010

(30) Foreign Application Priority Data
Nov. 2, 2007 (GB) 0721527.0

(51) Int. Cl. B01D 39/16; H05H 1/00; B01D 37/02

(52) U.S. Cl. 210/797; 427/488; 427/490; 427/491; 210/506; 210/767

(57) ABSTRACT

A method for maintaining pore size of a reusable filtration membrane, said method comprising exposing said filtration membrane to a plasma comprising a hydrocarbon or fluorocarbon monomer so as to form a polymeric layer on the surface thereof. The treatment allows the filtration membrane to withstand washing procedures, in particular caustic washing. Thus reusable filtration membranes treated in this way and their use, form a further aspect of the invention.

The present invention relates to filtration membranes, in particular reusable filtration membranes, as well as methods for treating these so that they retain consistent pore sizes, even when subject to harsh washing conditions, for example as found in a caustic wash.

Filtration of solids from liquids or gases is widely used in many fields including the biosciences, industrial processing, laboratory testing, food & beverage, electronics and water treatment. Membrane filters are porous or microporous films used to carry out these types of operation.

Membrane filters (which may also be known as screens, sieves, microporous filters, microfilters, ultrafilters or nanofilters) retain solid bodies such as particles or microorganisms etc. which are larger than their pore size, mainly by surface capture. Some particles smaller than the stated pore size may be retained by other mechanisms.

However, initial selection of membrane filters is generally on the basis of the pore size and the pore size distribution. The precise nature of the pores size is very important, since the pore size rating will effectively control the utility to which the membrane filter may be put.

In many cases, the filtration membrane may be used repeatedly or over prolonged periods. Frequently in such cases, it is vital that the membrane is properly washed or otherwise sanitised between uses, to avoid cross contamination. The pores of the filters can harbour particles including microorganisms, which may present other risks including health risks. Thus there is a need to use relatively harsh conditions including caustic washing agents to avoid these risks.

Because of the relatively fine and delicate nature of the porous structure, washing procedures, in particular where harsh chemicals such as the caustic chemicals found in many cleaning and sanitising products, can erode the membrane, so that the pores become larger with time. Therefore, it is important that where membrane filters are intended for repeated use that the pore size retains its integrity and consistency through repeated washing processes. Otherwise, the reliability of the filtering process may be jeopardised.

In order to achieve this reliability, the membranes are made from materials such as highly resistant and rigid polymers with a high modulus which have the desired characteristics. Examples may include PVDF and PTFE, but these materials tend to be fairly costly.

Plasma deposition techniques have been quite widely used for the deposition of polymeric coatings onto a range of surfaces, and in particular onto fabric surfaces. This technique is recognised as being a clean, dry technique that generates little waste compared to conventional wet chemical methods. Using this method, plasmas are generated from organic molecules, which are subjected to an electrical field. When this is done in the presence of a substrate, the radicals of the compound in the plasma polymerise on the substrate. Conventional polymer synthesis tends to produce structures containing repeat units that bear a strong resemblance to the monomer species, whereas a polymer network generated using a plasma can be extremely complex. The properties of the resultant coating can depend upon the nature of the substrate as well as the nature of the monomer used and conditions under which it is deposited.

The applicants have found that by treating filtration membranes using such a process the properties, in particular the resistance to repeated washing, may be enhanced significantly.

According to the present invention there is provided a method for maintaining pore size of a reusable filtration membrane, said method comprising exposing said filtration membrane to a plasma comprising a hydrocarbon or fluorocarbon monomer so as to form a polymeric layer on the surface thereof.

Treatment in this way has been found to make a reusable filtration membrane retain pore size much more consistently, even when subject to caustic washing.

As used herein, the expression “caustic washing” refers to any procedure in which chemical cleaning agents containing highly alkaline components such as sodium hydroxide are utilised. This includes many cleaning and sanitising products including bleaches and the like.

Suitable filtration membranes will be those made of a synthetic polymeric material. However, in view of the enhancement conveyed by the process of the invention, the polymeric material may generally be of a cheaper or lower cost polymer than has been used hitherto, where resistance to washing has proved to be a limiting factor. Thus for example, polyethylene filtration membranes may be produced which have good wash resistance and therefore may be used.

Depending upon the nature of the polymeric material deposited, the filtration membrane treated in this way may also be water and oil repellent, and also resistant to clogging. They may have useful “shake dry” properties also, reducing risk of contamination after washing.

Furthermore, the enhancement material or layer becomes molecularly bound to the surface and so there are no leachables; the modification becomes part of the membrane.

Membranes treated in accordance with the invention retain their porosity, as the coating layer deposited thereon is only molecules thick. Therefore, the liquid or even small particles can continue to pass through them, in particular when a positive pressure is applied to the liquid, or a negative pressure is applied to the other side of the membrane to draw the liquid through. However, larger particles will not pass through the membrane.

Any monomer that undergoes plasma polymerisation or modification of the surface to form a suitable polymeric coating layer or surface modification on the surface of the filtration membrane may suitably be used. Examples of such monomers include those known in the art to be capable of producing hydrophobic polymeric coatings on substrates by plasma polymerisation including, for example, carbonaceous compounds having reactive functional groups, particularly substantially —CF₃ dominated perfluoro compounds (see WO 97/38801), perfluorinated alkenes (Wang et al., Chem Mater 1996, 2212-2214), hydrogen containing unsaturated compounds optionally containing halogen atoms or perhalogenated organic compounds of at least 10 carbon atoms (see WO 98/58117), organic compounds comprising two double bonds (WO 99/64662), saturated organic compounds having an optionally substituted alky chain of at least 5 carbon atoms optionally interposed with a heteroatom (WO 00/05000), optionally substituted alkynes (WO 00/20130), polyether substituted alkenes (U.S. Pat. No. 6,482,531B) and macrocycles containing at least one heteroatom (U.S. Pat. No. 6,329,024B), the contents of all of which are herein incorporated by reference.

A particular group of monomers which may be used in the method of the present invention include compounds of formula (I)

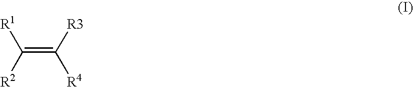

where R¹, R² and R³ are independently selected from hydrogen, alkyl, haloalkyl or aryl optionally substituted by halo; and R⁴ is a group —X—R⁵ where R⁵ is an alkyl or haloalkyl group and X is a bond; a group of formula —C(O)O—, a group of formula —C(O)O(CH₂)_{N}Y— where n is an integer of from 1 to 10 and Y is a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0; for a sufficient period of time to allow a polymeric layer to form on the surface.

As used therein the term “halo” or “halogen” refers to fluorine, chlorine, bromine and iodine. Particularly preferred halo groups are fluoro. The term “aryl” refers to aromatic cyclic groups such as phenyl or naphthyl, in particular phenyl. The term “alkyl” refers to straight or branched chains of carbon atoms, suitably of up to 20 carbon atoms in length. The term “alkenyl” refers to straight or branched unsaturated chains suitably having from 2 to 20 carbon atoms. “Haloalkyl” refers to alkyl chains as defined above which include at least one halo substituent.

Suitable haloalkyl groups for R¹, R², R³ and R⁵ are fluoroalkyl groups. The alkyl chains may be straight or branched and may include cyclic moieties.

For R⁵, the alkyl chains suitably comprise 2 or more carbon atoms, suitably from 2-20 carbon atoms and preferably from 4 to 12 carbon atoms.

For R¹, R² and R³, alkyl chains are generally preferred to have from 1 to 6 carbon atoms.

Preferably R⁵ is a haloalkyl, and more preferably a perhaloalkyl group, particularly a perfluoroalkyl group of formula CₘF₂ₘ₊₁ where m is an integer of 1 or more, suitably from 1-20, and preferably from 4-12 such as 4, 6 or 8.

Suitable alkyl groups for R¹, R² and R³ have from 1 to 6 carbon atoms.

In one embodiment, at least one of R¹, R² and R³ is hydrogen. In a particular embodiment R¹, R², R³ are all hydrogen. In yet a further embodiment however R³ is an alkyl group such as methyl or propyl.

Where X is a group —C(O)O(CH₂)ₙY—, n is an integer which provides a suitable spacer group. In particular, n is from 1 to 5, preferably about 2.

Suitable sulphonamide groups for Y include those of formula —N(R⁷)SO₂⁻ where R⁷ is hydrogen or alkyl such as C₁₋₄alkyl, in particular methyl or ethyl.

In one embodiment, the compound of formula (I) is a compound of formula (II)

CH₂═CH—R⁵ (II)

where R⁵ is as defined above in relation to formula (I).

In compounds of formula (II), ‘X’ within the X—R⁵ group in formula (I) is a bond.

However in a preferred embodiment, the compound of formula (I) is an acrylate of formula (III)

CH₂═CR^{7a}C(O)O(CH₂)ₙR⁵ (III)

where n and R⁵ as defined above in relation to formula (I) and R^{7a} is hydrogen, C₁₋₁₀ alkyl, or C₁₋₁₀haloalkyl. In particular R^{7a} is hydrogen or C₁₋₆alkyl such as methyl. A particular example of a compound of formula (III) is a compound of formula (IV)

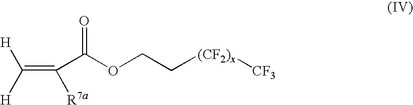

where R^{7a} is as defined above, and in particular is hydrogen and x is an integer of from 1 to 9, for instance from 4 to 9, and preferably 7. In that case, the compound of formula (IV) is 1H,1H,2H,2H-heptadecafluorodecylacylate.

According to a particular embodiment, the polymeric coating is formed by exposing the filtration membrane to plasma comprising one or more organic monomeric compounds, at least one of which comprises two carbon-carbon double bonds for a sufficient period of time to allow a polymeric layer to form on the surface.

Suitably the compound with more than one double bond comprises a compound of formula (V)

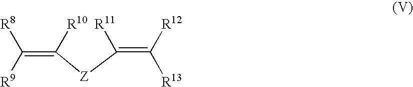

where R⁸, R⁹, R¹⁰, R¹¹, R¹², and R¹³ are all independently selected from hydrogen, halo, alkyl, haloalkyl or aryl optionally substituted by halo; and Z is a bridging group.

Examples of suitable bridging groups Z for use in the compound of formula (V) are those known in the polymer art. In particular they include optionally substituted alkyl groups which may be interposed with oxygen atoms. Suitable optional substituents for bridging groups Z include perhaloalkyl groups, in particular perfluoroalkyl groups.

In a particularly preferred embodiment, the bridging group Z includes one or more acyloxy or ester groups. In particular, the bridging group of formula Z is a group of sub-formula (VI)

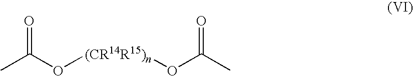

where n is an integer of from 1 to 10, suitably from 1 to 3, each R¹⁴ and R¹⁵ is independently selected from hydrogen, alkyl or haloalkyl.

Suitably R⁸, R⁹, R¹⁰, R¹¹, R¹², and R¹³ are haloalkyl such as fluoroalkyl, or hydrogen. In particular they are all hydrogen.

Suitably the compound of formula (V) contains at least one haloalkyl group, preferably a perhaloalkyl group.

Particular examples of compounds of formula (V) include the following:

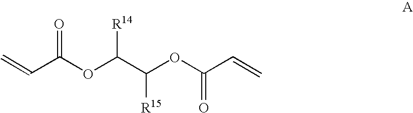

wherein R¹⁴ and R¹⁵ are as defined above and at least one of R¹⁴ or R¹⁵ is other than hydrogen. A particular example of such a compound is the compound of formula B.

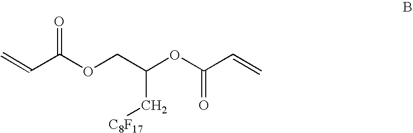

In a further embodiment, the polymeric coating is formed by exposing the filtration membrane to plasma comprising a monomeric saturated organic compound, said compound comprising an optionally substituted alkyl chain of at least 5 carbon atoms optionally interposed with a heteroatom for a sufficient period of time to allow a polymeric layer to form on the surface.

The term “saturated” as used herein means that the monomer does not contain multiple bonds (i.e. double or triple bonds) between two carbon atoms which are not part of an aromatic ring. The term “heteroatom” includes oxygen, sulphur, silicon or nitrogen atoms. Where the alkyl chain is interposed by a nitrogen atom, it will be substituted so as to form a secondary or tertiary amine. Similarly, silicons will be substituted appropriately, for example with two alkoxy groups.

Particularly suitable monomeric organic compounds are those of formula (VII)

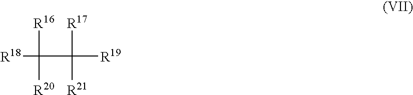

where R¹⁶, R¹⁷, R¹⁸, R¹⁹ and R²⁰ are independently selected from hydrogen, halogen, alkyl, haloalkyl or aryl optionally substituted by halo; and R²¹ is a group X—R²² where R²² is an alkyl or haloalkyl group and X is a bond or a group of formula —C(O)O(CH₂)ₓY— where x is an integer of from 1 to 10 and Y is a bond or a sulphonamide group; or a group —(O)ₚR²³(O)ₛ(CH₂)ₜ— where R²³ is aryl optionally substituted by halo, p is 0 or 1, s is 0 or 1 and t is 0 or an integer of from 1 to 10, provided that where s is 1, t is other than 0.

Suitable haloalkyl groups for R¹⁶, R¹⁷, R¹⁸, R¹⁹, and R²⁰ are fluoroalkyl groups. The alkyl chains may be straight or branched and may include cyclic moieties and have, for example from 1 to 6 carbon atoms.

For R²², the alkyl chains suitably comprise 1 or more carbon atoms, suitably from 1-20 carbon atoms and preferably from 6 to 12 carbon atoms.

Preferably R²² is a haloalkyl, and more preferably a perhaloalkyl group, particularly a perfluoroalkyl group of formula C_{z}F_{2z+1} where z is an integer of 1 or more, suitably from 1-20, and preferably from 6-12 such as 8 or 10.

Where X is a group —C(O)O(CH₂)_{y}Y—, y is an integer which provides a suitable spacer group. In particular, y is from 1 to 5, preferably about 2.

Suitable sulphonamide groups for Y include those of formula —N(R²³) SO₂⁻where R²³ is hydrogen, alkyl or haloalkyl such as C₁₋₄alkyl, in particular methyl or ethyl.

The monomeric compounds used in the method of the invention preferably comprises a C₆₋₂₅ alkane optionally substituted by halogen, in particular a perhaloalkane, and especially a perfluoroalkane.

According to another aspect, the polymeric coating is formed by exposing the filtration membrane to plasma comprising an optionally substituted alkyne for a sufficient period to allow a polymeric layer to form on the surface.

Suitably the alkyne compounds used in the method of the invention comprise chains of carbon atoms, including one or more carbon-carbon triple bonds. The chains may be optionally interposed with a heteroatom and may carry substituents including rings and other functional groups. Suitable chains, which may be straight or branched, have from 2 to 50 carbon atoms, more suitably from 6 to 18 carbon atoms. They may be present either in the monomer used as a starting material, or may be created in the monomer on application of the plasma, for example by the ring opening

Particularly suitable monomeric organic compounds are those of formula (VIII)

R²⁴—C≡C—X¹—R²⁵ (VIII)

where R²⁴ is hydrogen, alkyl, cycloalkyl, haloalkyl or aryl optionally substituted by halo; X¹ is a bond or a bridging group; and R²⁵ is an alkyl, cycloalkyl or aryl group optionally substituted by halogen.

Suitable bridging groups X¹include groups of formulae —(CH₂)ₛ—, —CO₂(CH₂)ₚ—, —(CH₂)ₚO(CH₂)_{q}—, —(CH₂)ₚN(R²⁶)CH₂)_{q}—, —(CH₂)ₚN(R²⁶)SO₂—, where s is 0 or an integer of from 1 to 20, p and q are independently selected from integers of from 1 to 20; and R²⁶ is hydrogen, alkyl, cycloalkyl or aryl. Particular alkyl groups for R²⁶ include C₁₋₆ alkyl, in particular, methyl or ethyl.

Where R²⁴ is alkyl or haloalkyl, it is generally preferred to have from 1 to 6 carbon atoms.

Suitable haloalkyl groups for R²⁴ include fluoroalkyl groups. The alkyl chains may be straight or branched and may include cyclic moieties. Preferably however R²⁴ is hydrogen.

Preferably R²⁵ is a haloalkyl, and more preferably a perhaloalkyl group, particularly a perfluoroalkyl group of where r is an integer of 1 or more, suitably from 1-20, and preferably from 6-12 such as 8 or 10.

In a particular embodiment, the compound of formula (VIII) is a compound of formula (IX)

CH≡C(CH₂)ₛ—R²⁷ (IX)

where s is as defined above and R²⁷ is haloalkyl, in particular a perhaloalkyl such as a C₆₋₁₂ perfluoro group like C₆F₁₃.

In another embodiment, the compound of formula (VIII) is a compound of formula (X)

CH≡C(O)O(CH₂)ₚR²⁷ (X)

where p is an integer of from 1 to 20, and R²⁷ is as defined above in relation to formula (IX) above, in particular, a group C₈F₁₇. Preferably in this case, p is an integer of from 1 to 6, most preferably about 2.

Other examples of compounds of formula (I) are compounds of formula (XI)

CH≡C(CH₂)ₚO(CH₂)_{q}R²⁷ , (XI)

where p is as defined above, but in particular is 1, q is as defined above but in particular is 1, and R²⁷ is as defined in relation to formula (IX), in particular a group C₆F₁₃;
or compounds of formula (XII)

CH≡C(CH₂)ₚN(R²⁶)(CH₂)_{q}R²⁷ (XII)

where p is as defined above, but in particular is 1, q is as defined above but in particular is 1, R²⁶ is as defined above an in particular is hydrogen, and R²⁷ is as defined in relation to formula (IX), in particular a group C₇F₁₅;
or compounds of formula (XIII)

CH≡C(CH₂)ₚN(R²⁶)SO₂R²⁷ (XIII)

where p is as defined above, but in particular is 1,R²⁶ is as defined above an in particular is ethyl, and R²⁷ is as defined in relation to formula (IX), in particular a group C₈F₁₇.

In an alternative embodiment, the alkyne monomer used in the process is a compound of formula (XIV)

R²⁸C≡C(CH₂)ₙ SiR²⁹R³⁰R³¹ (XIV)

where R^{H} is hydrogen, alkyl, cycloalkyl, haloalkyl or aryl optionally substituted by halo, R²⁹, R³⁰ and R³¹ are independently selected from alkyl or alkoxy, in particular C₁₋₆ alkyl or alkoxy.

Preferred groups R²⁸ are hydrogen or alkyl, in particular C₁₋₆ alkyl.

Preferred groups R²⁹, R³⁰ and R³¹ are C₁₋₆ alkoxy in particular ethoxy.

In general, the filtration membrane to be treated is placed within a plasma chamber together with the material to be deposited in gaseous state, a glow discharge is ignited within the chamber and a suitable voltage is applied, which may be pulsed.

The polymeric coating may be produced under both pulsed and continuous-wave plasma deposition conditions but pulsed plasma may be preferred as this allows closer control of the coating, and so the formation of a more uniform polymeric structure.

As used herein, the expression “in a gaseous state” refers to gases or vapours, either alone or in mixture, as well as aerosols.

Precise conditions under which the plasma polymerization takes place in an effective manner will vary depending upon factors such as the nature of the polymer, the filtration membrane treated including both the material from which it is made and the pore size etc. and will be determined using routine methods and/or the techniques.

Suitable plasmas for use in the method of the invention include non-equilibrium plasmas such as those generated by radiofrequencies (RF), microwaves or direct current (DC). They may operate at atmospheric or sub-atmospheric pressures as are known in the art. In particular however, they are generated by radiofrequencies (RF).

Various forms of equipment may be used to generate gaseous plasmas. Generally these comprise containers or plasma chambers in which plasmas may be generated. Particular examples of such equipment are described for instance in WO2005/089961 and WO02/28548, but many other conventional plasma generating apparatus are available.

The gas present within the plasma chamber may comprise a vapour of the monomer alone, but it may be combined with a carrier gas, in particular, an inert gas such as helium or argon, if required. In particular helium is a preferred carrier gas as this can minimise fragmentation of the monomer.

When used as a mixture, the relative amounts of the monomer vapour to carrier gas is suitably determined in accordance with procedures which are conventional in the art. The amount of monomer added will depend to some extent on the nature of the particular monomer being used, the nature of the substrate being treated, the size of the plasma chamber etc. Generally, in the case of conventional chambers, monomer is delivered in an amount of from 50-250 mg/minute, for example at a rate of from 100-150 mg/minute. It will be appreciated however, that the rate will vary depending on the reactor size chosen and the number of substrates required to be processed at once; this in turn depends on considerations such as the annual through-put required and the capital outlay.

Carrier gas such as helium is suitably administered at a constant rate for example at a rate of from 5-90 standard cubic centimetres per minute (sccm), for example from 15-30 sccm. In some instances, the ratio of monomer to carrier gas will be in the range of from 100:0 to 1:100, for instance in the range of from 10:0 to 1:100, and in particular about 1:0 to 1:10. The precise ratio selected will be so as to ensure that the flow rate required by the process is achieved.

In some cases, a preliminary continuous power plasma may be struck for example for from 15 seconds to 10 minutes, for example from 2-10 minutes within the chamber. This may act as a surface pre-treatment step, ensuring that the monomer attaches itself readily to the surface, so that as polymerisation occurs, the coating “grows” on the surface. The pre-treatment step may be conducted before monomer is introduced into the chamber, in the presence of only an inert gas.

The plasma is then suitably switched to a pulsed plasma to allow polymerisation to proceed, at least when the monomer is present.

In all cases, a glow discharge is suitably ignited by applying a high frequency voltage, for example at 13.56 MHz. This is applied using electrodes, which may be internal or external to the chamber, but in the case of larger chambers are generally internal.

Suitably the gas, vapour or gas mixture is supplied at a rate of at least 1 standard cubic centimetre per minute (sccm) and preferably in the range of from 1 to 100 sccm.

In the case of the monomer vapour, this is suitably supplied at a rate of from 80-300 mg/minute, for example at about 120 mg/minute depending upon the nature of the monomer, the size of the chamber and the surface area of the product during a particular run whilst the pulsed voltage is applied. It may however, be more appropriate for industrial scale use to have a fixed total monomer delivery that will vary with respect to the defined process time and will also depend on the nature of the monomer and the technical effect required.

Gases or vapours may be delivered into the plasma chamber using any conventional method. For example, they may be drawn, injected or pumped into the plasma region. In particular, where a plasma chamber is used, gases or vapours may be drawn into the chamber as a result of a reduction in the pressure within the chamber, caused by use of an evacuating pump, or they may be pumped, sprayed, dripped, electrostatically ionised or injected into the chamber as is common in liquid handling.

Polymerisation is suitably effected using vapours of compounds for example of formula (I), which are maintained at pressures of from 0.1 to 400 mtorr, suitably at about 10-100 mtorr.

The applied fields are suitably of power of from 5 to 500 W for example from 20 to 500 W, suitably at about 100 W peak power, applied as a continuous or pulsed field. Where used, pulses are suitably applied in a sequence which yields very low average powers, for example in a sequence in which the ratio of the time on: time off is in the range of from 1:500 to 1:1500. Particular examples of such sequence are sequences where power is on for 20-50 μs, for example about 30 μs, and off for from 1000 μs to 30000 μs, in particular about 20000 μs. Typical average powers obtained in this way are 0.01W.

The fields are suitably applied from 30 seconds to 90 minutes, preferably from 5 to 60 minutes, depending upon the nature of the compound of formula (I) and the filtration membrane.

Suitably a plasma chamber used is of sufficient volume to accommodate multiple membranes.

A particularly suitable apparatus and method for producing filtration membranes in accordance with the invention is described in WO2005/089961, the content of which is hereby incorporated by reference.

In particular, when using high volume chambers of this type, the plasma is created with a voltage as a pulsed field, at an average power of from 0.001 to 500 W/m³, for example at from 0.001 to 100 W/m³ and suitably at from 0.005 to 0.5W/m³.

These conditions are particularly suitable for depositing good quality uniform coatings, in large chambers, for example in chambers where the plasma zone has a volume of greater than 500 cm³, for instance 0.1 m³ or more, such as from 0.5 m³-10 m³ and suitably at about 1 m³. The layers formed in this way have good mechanical strength.

The dimensions of the chamber will be selected so as to accommodate the particular filtration membrane or batch of membranes being treated. For instance, generally cuboid chambers may be suitable for a wide range of applications, but if necessary, elongate or rectangular chambers may be constructed or indeed cylindrical, or of any other suitable shape.

The chamber may be a sealable container, to allow for batch processes, or it may comprise inlets and outlets for the filtration membranes, to allow it to be utilised in a continuous process as an in-line system. In particular in the latter case, the pressure conditions necessary for creating a plasma discharge within the chamber are maintained using high volume pumps, as is conventional for example in a device with a “whistling leak”. However it will also be possible to process filtration membranes at atmospheric pressure, or close to, negating the need for “whistling leaks”.

A further aspect of the invention comprises a reusable filtration membrane which has been treated by a method as described above. In particular, the membrane is of a synthetic polymeric material, such as polyethylene.

In yet a further aspect, the invention provides a method of filtering a liquid, said method comprising passing a sample of liquid through a filtration membrane as described above, and after use, washing the filtration membrane in a caustic or other cleaning solution in preparation for reuse.

In yet a further aspect, the invention provides the use of a polymerised fluorocarbon or hydrocarbon coating, deposited by a plasma polymerisation process, for making a filtration membrane resistant to chemical attack, such as that to which they are subjected during cleaning. Suitable fluorocarbon and hydrocarbon coatings are obtainable as described above.

The invention will now be particularly described by way of example, with reference to the accompanying diagrammatic drawings in which:

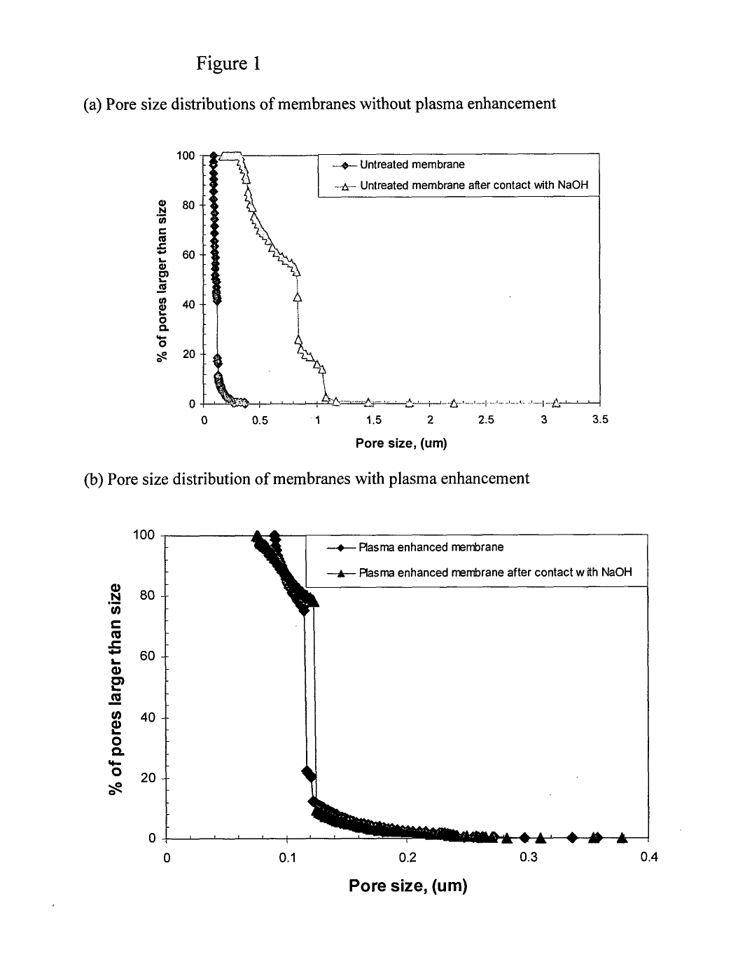

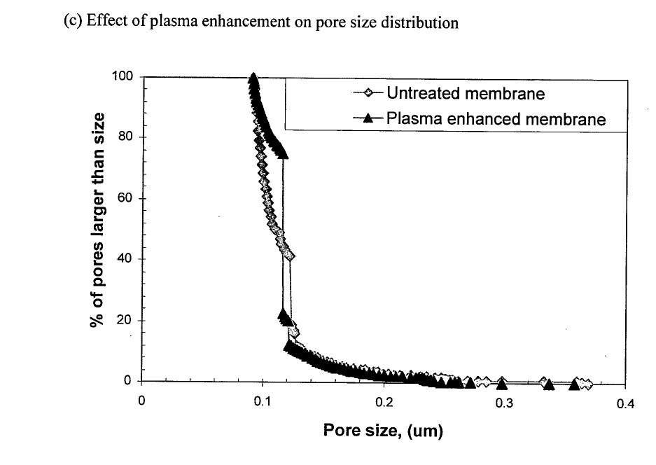

FIG. 1 is a series of graphs showing the pores size distribution data for the filtration membrane sold as E-14PO2E samples, plotted as cumulative oversize curves; wherein (a) shows the results of membranes without treatment in accordance with the method of the invention before () and after (▴) washing in caustic soda; (b) shows the results of membranes treated in accordance with the method of the invention before () and after (▴)washing in caustic soda; and (c) shows the results of membranes before () and after (▴) treatment using the method of the invention; and

### EXAMPLE 1

### Wash Test

A series of membranes were produced by subjecting a polyethylene filtration membrane, sold as E-14PO2E, to a plasma procedure. Samples of E-14PO2E were placed into a plasma chamber with a processing volume of ˜300 litres. The chamber was connected to supplies of the required gases and or vapours, via a mass flow controller and/or liquid mass flow meter and a mixing injector or monomer reservoir as appropriate.

The chamber was evacuated to between 3 and 10 mtorr base pressure before allowing helium into the chamber at 20 sccm until a pressure of 80 mtorr was reached. A continuous power plasma was then struck for 4 minutes using RF at 13.56 MHz at 300 W.

After this period, 1H,1H,2H,2H-heptadecafluorodecylacylate (CAS #27905-45-9) of formula

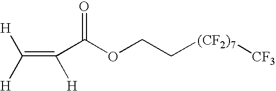

was brought into the chamber at a rate of 120 milligrams per minute and the plasma switched to a pulsed plasma at 30 microseconds on-time and 20 milliseconds off-time at a peak power of 100 W for 40 minutes. On completion of the 40 minutes the plasma power was turned off along with the processing gases and vapours and the chamber evacuated back down to base pressure. The chamber was then vented to atmospheric pressure and the membrane samples removed.

The pore size distribution of both a treated and untreated membrane was measured both before and after immersion in caustic soda (NaOH) solution. Caustic soda (NaOH) was used in the tests as it is a component of many cleaning and sanitising chemicals for membranes. For example, Floclean MC11 is used for the removal of foulants composed of organics, silts, or biological materials from membranes and contains 1% NaOH; to remove fats and oils, proteins, polysaccharides, and bacteria from membranes by hydrolysis and oxidation, a solution containing 0.5N NaOH is recommended (C. Munir, Ultrafiltration and Microfiltration Handbook, 2^{nd} edition, CRC Press).

The pores size distribution data for untreated and treated membranes is shown in FIG. 1(a) and (1b) respectively.

The results show that in the untreated membrane, the pore sizes have been increased considerably by the NaOH. This results from damage to the pore structure, and points to the fact that the sample is not chemically resistant to NaOH. However, the pore size remained largely constant in the treated membrane indicating a high level of NaOH resistance. Therefore, the treatment protected the sample from NaOH attack. The pore size distribution was not changed by the NaOH immersion.

### EXAMPLE 2

### Effect on Pore Size of Treatment

The pore size distributions of the E-14PO2E membrane samples before and after treatment as described in Example 1 were also measured. The pore size distribution was found to be narrow; which is advantageous for filtration applications, where the ‘best’ membranes would have a monosized distribution of pore sizes. Taking account of the errors in the measurement technique, there appears to be no significant difference between the pore size distributions of the two membranes, indicating that this remains unaffected by the treatment.

1-23. (canceled)

24. A method for maintaining pore size of a reusable filtration membrane comprising exposing the filtration membrane to a plasma comprising a hydrocarbon or fluorocarbon monomer to form a polymeric layer on a surface of the filtration membrane.

25. The method of claim 24, further comprising subjecting the reusable filtration membrane to caustic washing.

26. The method of claim 24, wherein the reusable filtration membrane consists essentially of synthetic polymeric material.

27. The method of claim 26, wherein the synthetic polymeric material consists essentially of polyethylene.

28. The method of claim 24, wherein the plasma is pulsed.

29. The method of claim 28, further comprising, in a preliminary step, applying a continuous power plasma to the filtration membrane.

30. The method of claim 24, wherein the monomer is a compound of formula (I) 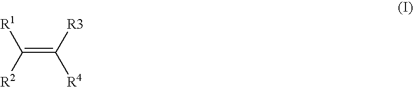
where R¹, R² and R³ independently are selected from hydrogen, alkyl, haloalkyl or aryl optionally substituted by halo; and R⁴ is a group X—R⁵ where R⁵ is an alkyl or haloalkyl group and X is a bond, a group of formula —C(O)O(CH₂),Y— where n is an integer of from 1 to 10 and Y is a bond or a sulphonamide group, or a group —(O)ₚR⁶(O)_{q}(CH₂)ₜ— where R⁶ is aryl optionally substituted by halo, p is 0 or 1, q is 0 or 1, and t is 0 or an integer from 1 to 10, provided that where q is 1, t is not 0.

31. The method of claim 30, wherein the compound of formula (I) is a compound of formula (II)
CH₂═CH—R⁵ (II)
where R⁵ is an alkyl or haloalkyl group.

32. The method of claim 30, wherein the compound of formula (I) is a compound of formula (III)
CH₂═CR^{7a}C(O)O(CH₂),R⁵ (III)
where n is an integer of from 1 to 10, R⁵ is an alkyl or haloalkyl group, and R^{7a} is hydrogen, C₁₋₁₀ alkyl, or C₁₋₁₀haloalkyl.

33. The method of claim 32, wherein the compound of formula (III) is a compound of formula (IV) 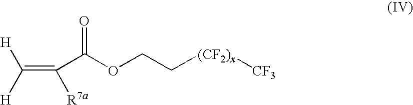
where R^{7a} is hydrogen, C₁₋₁₀ alkyl, or C₁₋₁₀haloalkyl, and x is an integer of from 1 to 9.

34. The method of claim 33, wherein the compound of formula (IV) is 1H,1H,2H,2H-heptadecafluorodecylacylate.

35. The method of claim 24, further comprising placing the reusable filtration membrane in a plasma deposition chamber, igniting a glow discharge within the chamber, and applying a pulsed voltage.

36. The method of claim 35, wherein the voltage is applied at a power of from 40 to 500 W.

37. The method of claim 35, wherein the voltage is pulsed in a sequence in which the ratio of time on to time off is from 1:500 to 1:1500.

38. The method of claim 35, further comprising, in a preliminary step, applying a continuous power plasma to the filtration membrane.

39. The method of claim 38, wherein the preliminary step is conducted in the presence of an inert gas.

40. The method of claim 36, wherein the voltage is pulsed in a sequence in which the ratio of time on to time off is from 1:500 to 1:1500, the reusable filtration membrane consists essentially of a polyethylene material, and the monomer is 1H,1H,2H,2H-heptadecafluorodecylacylate.

41. A reusable filtration membrane consisting essentially of a synthetic polymeric material that has been treated with a plasma comprising a hydrocarbon or fluorocarbon monomer to form a polymeric layer on a surface of the filtration membrane.

42. The reusable filtration membrane of claim 41, wherein the synthetic polymeric material consists essentially of a polyethylene material.

43. A method of filtering a liquid comprising passing the liquid through a filtration membrane consisting essentially of a synthetic polymeric material that has been treated with a plasma comprising a hydrocarbon or fluorocarbon monomer to form a polymeric layer on a surface of the filtration membrane.

44. The method of claim 43, further comprising a subsequent step of washing the filtration membrane in a caustic solution.
